(19) United States
(12) Patent Application Publication
(10) Pub. No.: US 2016/0111696 A1
(43) Pub. Date: Apr. 21, 2016

(54) METHOD FOR MAKING POLYIMIDE MICROPOROUS SEPARATOR

(71) Applicants: Jiangsu Huadong Institute of Li-ion Battery Co. Ltd., Zhangjiagang (CN); Tsinghua University, Beijing (CN)

(72) Inventors: YU-MING SHANG, Beijing (CN); YAO-WU WANG, Beijing (CN); XIANG-MING HE, Beijing (CN); JIAN-JUN LI, Beijing (CN); LI WANG, Beijing (CN); PENG ZHAO, Beijing (CN); JU-PING YANG, Beijing (CN)

(21) Appl. No.: 14/980,487

(22) Filed: Dec. 28, 2015

Related U.S. Application Data
(63) Continuation of application No. PCT/CN2014/080843, filed on Jun. 26, 2014.

(30) Foreign Application Priority Data
Jun. 27, 2013 (CN) 201310262980.8

(51) Int. Cl. H01M 2/14; H01M 10/0525; H01M 2/16; C08J 5/22

(52) U.S. Cl. CPC H01M 2/145; C08J 5/2256; H01M 10/0525; H01M 2/1653; C08J 2379/08

(57) ABSTRACT

A method for making a polyimide microporous separator comprising: using a flexible monomer to prepare a soluble polyimide by a one-step method, and forming a polyimide liquid solution; providing an inorganic template of inorganic nanoparticles, and surface treating the inorganic template with a surface treatment agent in an organic solvent to dissolve the inorganic template in the organic solvent, thereby forming an inorganic template liquid dispersion; mixing the polyimide liquid solution with the inorganic template liquid dispersion and agitation to form a film forming liquid; coating the film forming liquid on a substrate to form an organic-inorganic composite film; and disposing the organic-inorganic composite film into a template removing agent, the inorganic template in the organic-inorganic composite film reacting with the template removing agent to remove the inorganic template from the organic-inorganic composite film.

### CROSS-REFERENCE TO RELATED APPLICATIONS

This application claims all benefits accruing under 35 U.S.C. §119 from China Patent Applications No. 201310262980.8, filed on Jun. 27, 2013 in the China Intellectual Property Office, the content of which is hereby incorporated by reference. This application is a continuation under 35 U.S.C. §120 of international patent application PCT/CN2014/080843 filed Jun. 26, 2014, the content of which is hereby incorporated by reference.

### FIELD

The present disclosure belongs to chemical material preparation filed, and specifically relates to a method for making polyimide microporous separator.

### BACKGROUND

As the use of the lithium ion batteries increases greatly in new energy fields such as mobile phones, electric vehicles, and energy storage systems, safety becomes an issue. To the safety of the lithium ion battery, cause based analyzing can be done to make improvements: one is to optimize design and management of the lithium ion batteries, which monitor the charge and discharge processes of the lithium ion batteries in real-time and handle the safe maintenance issues of the lithium ion batteries. Another is to improve or develop new electrode materials, which increase an intrinsic safety performance of the battery. Third is to use new and safe type electrolytes and separators in the lithium ion batteries.

A separator is a critical component in lithium ion battery prevents a short circuit between the anode and cathode electrodes and is capable of passing electrolyte ions. A conventional lithium ion battery separator is a microporous film formed by polyolefin such as polypropylene (PP) and polyethylene (PE) uses physical (such as extending) or chemical (such as extraction) methods. Commercial separator products are provided by Japanese Asahi, Tonen, and Ube, and American Celgard companies. A matrix of the separator, polyolefin has a high strength and a good stability in acids, alkalis, and solvents. However, the melting point of polyolefin is relatively low (the melting point of PE is about 130° C., and the melting point of PP is about 160° C.), which causes a contraction and meltdown of the separator at high temperature, which may induce a burning or exploding battery.

Therefore, it is important to prepare and use high temperature enduring separator to improve the safety of the lithium ion battery.

### SUMMARY

What is need is to provide a method for making a polyimide microporous separator having high temperature endurance.

A method for making a polyimide microporous separator includes the following steps: a flexible monomer is used to prepare a soluble polyimide by a one-step method, and a polyimide liquid solution is formed; an inorganic template of inorganic nanoparticles is provided, and the inorganic template is surface treated with a surface treatment agent in an organic solvent to dissolve the inorganic template in the organic solvent, thereby forming an inorganic template liquid dispersion; the polyimide liquid solution is mixed with the inorganic template liquid dispersion and ultrasonically agitated to form a film forming liquid; the film forming liquid is coated on a surface of a substrate and dried to form an organic-inorganic composite film; and the organic-inorganic composite film is disposed into a liquid solution of a template removing agent, the inorganic template in the organic-inorganic composite film reacts with the template removing agent to remove the inorganic template from the organic-inorganic composite film, thereby achieving the polyimide microporous separator. A method for forming the polyimide liquid solution includes the following steps: using a protective gas, a dianhydride monomer and a diamine monomer are added into an organic solvent to form a mixed liquid; the mixed liquid is stirred to dissolve the dianhydride monomer and the diamine monomer in the organic solvent, and after that, a catalyst is added to fully react at 160° C. to 200° C. to form the polyimide; and dissolving the polyimide in an organic solvent to form the polyimide liquid solution.

Compared to prior art, as illustrated in the method for making the polyimide microporous separator of the present disclosure, the inorganic template is surface decorated with a surface treatment agent rendering the inorganic template to be in a hydrophobic state. The surface decorated inorganic template is mixed with the polyimide liquid solution to form the organic-inorganic composite film. The inorganic template is removed from the organic-inorganic composite film by the template removing agent. The polyimide microporous separator is achieved after drying. The polyimide microporous separator has a high temperature endurance. The thermal contraction at 150° C. of the polyimide microporous separator is substantially zero, which greatly improves the safety of the lithium ion battery.

### BRIEF DESCRIPTION OF THE DRAWINGS

The FIGURE is a graph showing rate capability testing results of 2032 coin type battery using a polyimide microporous separator.

### DETAILED DESCRIPTION

A detailed description with drawings and embodiments is made to the method for making a polyimide microporous separator of the present disclosure.

The method for making the polyimide microporous separator of the present disclosure including steps of:

Step 1, using a flexible monomer to prepare a soluble polyimide by a one-step method, and forming a polyimide liquid solution;

Step 2, providing an inorganic template, and surface treating the inorganic template with a surface treatment agent in the organic solvent to dissolve the inorganic template in the organic solvent, thereby forming an inorganic template liquid dispersion;

Step 3, mixing the polyimide liquid solution with the inorganic template liquid dispersion and ultrasonically agitating the mixture to form a film forming liquid;

Step 4, coating the film forming liquid on a surface of a substrate and drying the coated surface to form an organic-inorganic composite film; and

Step 5, disposing the organic-inorganic composite film into a liquid solution of a template removing agent, the inorganic template in the organic-inorganic composite film reacting with the template removing agent to remove the inorganic template from the organic-inorganic composite film, thereby achieving the polyimide microporous separator.

Polyimide is conventionally prepared by a two-step method. First, a dianhydride monomer and a diacid monomer are copolymerized at room temperature to form a polyacrylic acid as an intermediate. Then, an imidization is made to the polyacrylic acid by treating the polyacrylic acid at a high temperature (such as 300° C. to 400° C.) to form the polyimide. However, at the high temperature, a cross-linking tends to occur among the molecular chains to render the polyimide insoluble. In addition, the choosing of the monomer is also a critical matter, as a monomer has a relatively high rigidity an insoluble polyimide may also form. The insoluble polyimide is not suitable for compositing with the inorganic template to form a composite film.

In step 1, the present disclosure forms the soluble polyimide from a flexible monomer by using the one-step method at a moderate temperature, and further forms the polyimide liquid solution, which includes the steps of:

S11, in a protective gas, a dianhydride monomer and a diamine monomer are added into an organic solvent to form a mixed liquid;

S12, the mixed liquid is stirred to completely dissolve the dianhydride monomer and the diamine monomer in the organic solvent, and next, a catalyst is added to fully react at 160° C. to 200° C. to form the polyimide;

S13, the polyimide is dissolved in an organic solvent to form the polyimide liquid solution.

In step S11, the protective gas can be nitrogen gas or inert gas, such as argon gas. The weights of the dianhydride monomer, diamine monomer, and organic solvent are decided according to a solid content, which is 4 wt %-20 wt %, of the polymer. The polymer is copolymerized from the two monomers and has the same weight. Therefore, the solid content of the polymer is equal to a weight percentage of the total weight of the dianhydride monomer and the diamine monomer in the mixed liquid.

The dianhydride monomer and the diamine monomer are both flexible monomers. The dianhydride monomer is at least one of compounds having structural formulas (1-1), (1-2), and (1-3).

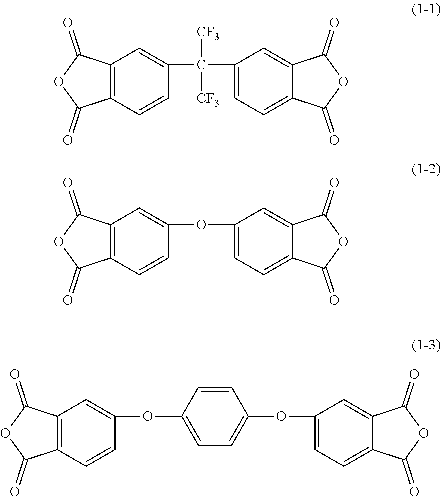

The diamine monomer is at least one of compounds having structural formulas (2-1), (2-2), (2-3), (2-4), (2-5), (2-6), (2-7), (2-8), (2-9), and (2-10).

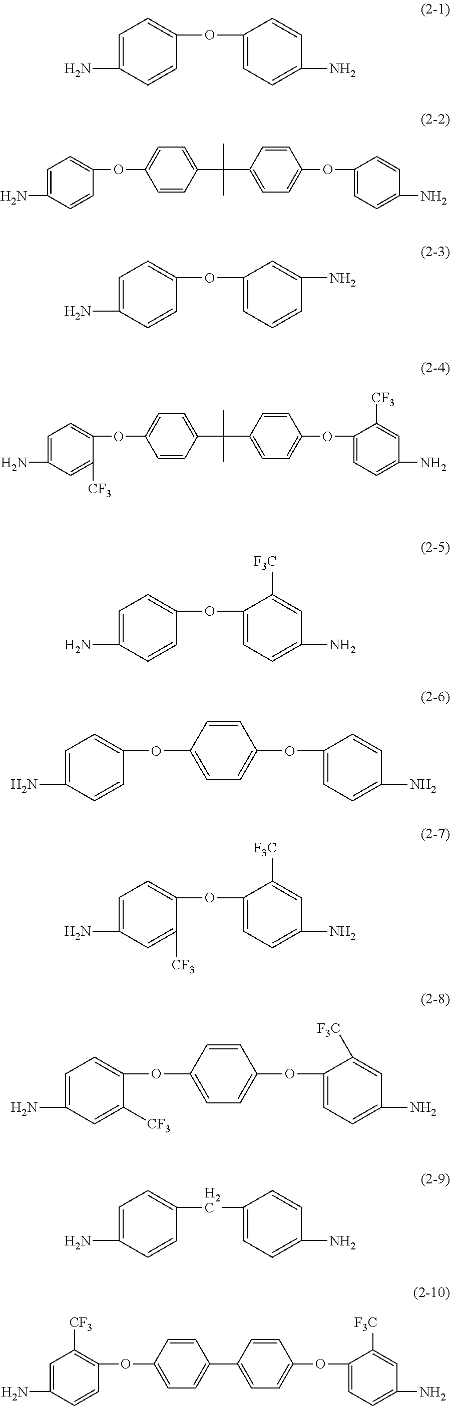

A mole ratio between all the diamine monomer and all the dianhydride monomer is 1:1 to 1:1.05.

The organic solvent can be at least one of dimethylformamide (DMF), dimethylacetamide (DMAC), 1,2-dichloroethane, dimethylsulfoxide (DMSO), diphenyl sulfone, sulfolane, and 1-Methyl-2-pyrrolidinone (NMP).

In step S12, the mixed liquid can be stirred at room temperature. After the catalyst is added, the temperature of the mixed liquid can be slowly increased to 160° C.-200° C. Then, the mixed liquid having the catalyst is stirred at this temperature for 12 hours-48 hours (e.g., 24 hours).

By using the flexible diamine monomer and dianhydride monomer, and controlling the temperature, the diamine monomer and the dianhydride monomer can directly form the soluble polyimide at the temperature 160° C.-200° C., which is a one-step reaction. The soluble polyimide can be dissolved in an aprotic solvent. The polyimide product obtained in step S12 is a viscid polymer solution.

After step S12, a purification can be applied to the polyimide product, wherein the viscid polymer solution can be washed with a washing solvent and dried to obtain a solid soluble polyimide. The catalyst is dissolved in the washing solvent, and the polyimide is insoluble in the washing solvent and becomes a precipitate. The washing solvent can be water, methanol water solution (the concentration of the methanol can be 5-99 wt %), or ethanol water solution (the concentrations of the ethanol can be 5-99 wt %).

The catalyst can be at least one of benzoic acid, benzenesulfonic acid, toluenesulfonic acid, phenylacetic acid, pyridine, quinoline, isoquinoline, isoquinolin-8-ol

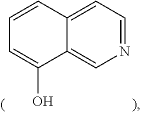 [SMILES: Oc1cccc2ccncc12]

pyrrole, and imidazole. An amount of the catalyst can be 0.1-5 wt % of the total amount of the dianhydride monomer and the diamine monomer.

When the catalyst is alkaline, an azeotropic water separation agent can be further added.

The azeotropic water separation agent can be at least one of benzene, hexane, toluene, m-xylene, p-xylene, and o-xylene. A mass of the azeotropic water separation agent can be 2-20 times of the total amount of the dianhydride monomer and the diamine monomer. When the catalyst is acid, azeotropic water separation agent can be excluded.

In step S13, the mass percentage of the polyimide in the polyimide liquid solution is 5 wt %-20 wt %. The organic solvent in step S13 can be the aprotic solvent, such as at least one of dimethylformamide, dimethylacetamide, 1,2-dichloroethane, dimethyl sulfoxide, diphenyl sulfone, sulfolane, and NMP.

The step 2 can further include steps of: uniformly mixing the inorganic template and the surface treatment agent in the organic solvent to form a mixture; increasing the temperature of the mixture to 40° C.-80° C.; and ultrasonically treating the mixture at 40° C.-80° C. for 2 hours-8 hours.

The inorganic template can be inorganic nanoparticles made of metal oxides which do not chemically react with the polyimide liquid solution. The inorganic template can be at least one of silicon dioxide (SiO₂) nanoparticles, titanium dioxide (TiO₂) nanoparticles, aluminum oxide (Al₂O₃) nanoparticles, calcium carbonate (CaCO₃) nanoparticles, magnesium hydroxide (Mg(OH)₂) nanoparticles, magnesium oxide (MgO) nanoparticles, magnesium carbonate (MgCO₃) nanoparticles, barium carbonate (BaCO₃) nanoparticles, zinc hydroxide (Zn(OH)₂) nanoparticles, and zinc carbonate (ZnCO₃) nanoparticles. The mass ratio of the inorganic template to the organic solvent can be 0.05:1-0.5:1.

The surface treatment agent can render the inorganic template to be hydrophobic to improve the dispersing ability of the inorganic template in the organic solvent. The surface treatment agent can be a silane coupling agent, such as at least one of vinyltrimethoxysilane, vinyltrimethoxysilane, γ-methacryloxypropyltrimethoxysilane, γ-(Triethoxysilyl)propyl methacrylate, methyltrimethoxysilane, 3-glycidoxypropyltrimethoxysilane, γ-aminopropyltriethoxysilane, triethoxy(isobutyl)silane, and butadiene triethoxysilane. A mass ratio of the surface treatment agent to the inorganic template can be 0.001:1-0.05:1.

The organic solvent in step 2 can be the same kind as the organic solvent in step 1, and can be at least one of dimethylformamide (DMF), dimethylacetamide (DMAC), 1,2-dichloroethane, dimethylsulfoxide (DMSO), diphenyl sulfone, sulfolane, and 1-Methyl-2-pyrrolidinone (NMP).

In step 3, the solution formed by mixing the polyimide liquid solution and the inorganic template liquid dispersion can be ultrasonically agitated. The time of the ultrasonically agitation can be 0.5 hours-8 hours. The polyimide liquid solution and the inorganic template liquid dispersion are mixed according to a mass ratio of the inorganic template to the polyimide, and the mass ratio is 0.3:1-2:1. The inorganic template is hydrophobic because of treating with the surface treatment agent. Thus, when mixing the polyimide liquid solution with the inorganic template liquid dispersion, the inorganic template can be uniformly dispersed in the polyimide liquid solution.

In step 4, the film forming liquid can be coated on the surface of the substrate by knife coating, spraying, or tape casting. The coating of the film forming liquid is rested at 50° C.-80° C. for 0.5 hours-24 hours, and then dried at 100° C.-120° C. for 0.5 hours-24 hours, following by demolding to achieve the organic-inorganic composite film. The demolding step can be removing the organic-inorganic composite film from the substrate. The organic-inorganic composite film includes a matrix which is the polyimide and the inorganic template dispersed in the polyimide matrix.

In step 5, the template removing agent is capable of having a chemical reaction with the inorganic template to remove the inorganic template from the organic-inorganic composite film. Specifically, the template removing agent can be acid, such as at least one of hydrochloric acid, hydrofluoric acid, sulfuric acid, nitric acid, acetic acid, and formic acid. The acid can be dissolved to a solvent, such as water, to form a solution. A concentration of the acid can be 5-40 wt %.

In the organic-inorganic composite film, the inorganic template is nanoparticles that are uniformly dispersed in the polyimide matrix, and then by reacting the inorganic template with the nanoparticles, the nanoparticles can be removed from the polyimide substrate. The polyimide does not react with the inorganic template, and maintain the same structure as before, thereby forming micropores at the nanoparticles to form the polyimide microporous separator.

In the embodiment, the organic-inorganic composite film can be treated with the template removing agent at 30° C.-80° C. for about 0.5 hours-24 hours. The achieved polyimide microporous separator can be further purified by washing with water and drying at 80° C.-120° C. for about 1 hour-24 hours in vacuum to obtain the product.

The embodiments of the present disclosure use the inorganic template as the template, and produce a high temperature endurance polyimide microporous separator for the battery by a template method. The endurance of the polyimide matrix is above 150° C. Unlike a conventional method processed at 400° C., the separator can be made at a relatively low temperature as the polyimide is soluble, which decreases the power consumption and avoids a high temperature phase separation between the organic and inorganic substances that have a different thermal expansion coefficient to improve the uniformity. The surface treating of the inorganic template can dramatically increase the maximum amount of the inorganic template that is capable of dispersing in the polyimide, thereby increasing the porosity of the separator, which can reach 50%. The thermal contraction of the polyimide microporous separator is substantially zero, which greatly improves the safety of the lithium ion battery. The lithium ion battery using the polyimide microporous separator has a relatively good performance rating. The polyimide microporous separator can play an important role in lithium ion battery, and other fields such as sodium ion battery, membrane separation, and sensor. The method is easy to be managed and suitable for a mass production, and has a low cost.

### Example 1

4.02 g of dianhydride monomer represented by the formula (1-3) and 2.0 g of diamine monomer represented by the formula (2-1) are added to 114 g of a mixture of dimethylacetamide and diphenyl sulfone (mass ratio is 1:1), in nitrogen gas and stirred for about 0.5 hours at room temperature. After the dianhydride monomer and the diamine monomer are thoroughly dissolved, 0.006 g of benzoic acid is added, and the mixture is heated slowly to 180° C. then stirred at this temperature for about 24 hours to obtain a viscid polymer solution. The viscid polymer solution is precipitated in water and repeatedly washed, and then dried to achieve the soluble polyimide. The soluble polyimide is dissolved in NMP to form 20 wt % of polyimide liquid solution.

20 g of SiO₂ nanoparticles is added to 400 g of NMP and stirred to be uniformly dispersed in the NMP followed by adding 0.02 g of vinyltrimethoxysilane as the surface treatment agent and ultrasonically treating the surface at 60° C. for 2 hours to achieve the inorganic template liquid dispersion.

5 g of the prepared polyimide liquid solution and 42 g of the prepared inorganic template liquid dispersion are mixed by stirring for 30 minutes and ultrasonically agitated for 30 minutes to form the film forming liquid.

The film forming liquid is tape casted at a surface of a substrate, rested at 50° C. for 24 hours, dried at 120° C. for 0.5 hours, and demolded to obtain the organic-inorganic composite film.

The organic-inorganic composite film is disposed in HF water solution having the concentration of 5% at 30° C. for 24 hours, repeatedly washed with deionized water, and then heated at 120° C. in vacuum for 1 hour to achieve the polyimide microporous separator. The properties of the polyimide microporous separator are shown in Table 1.

### Example 2

31.0 g of dianhydride monomer represented by the formula (1-2), 20.5 g of diamine monomer represented by the formula (2-2), and 10.0 g of diamine monomer represented by the formula (2-3) are added to 240 g of sulfolane, in argon gas, and stirred for about 1 hours at room temperature. After the dianhydride monomer and the diamine monomers are thoroughly dissolved, 0.6 g of benzenesulfonic acid is added, and the mixture is heated slowly to 200° C. followed by stirring at this temperature for about 24 hours to obtain a viscid polymer solution. The viscid polymer solution is precipitated in methanol water solution having the concentration of 5 wt % and repeatedly washed, and then dried to achieve the soluble polyimide. The soluble polyimide is dissolved in dimethylacetamide to form 5 wt % of polyimide liquid solution.

30 g of TiO₂ nanoparticles is added to 100 g of dimethylsulfoxide and stirred to be uniformly dispersed in the dimethylsulfoxide followed by adding 1.5 g of butadiene triethoxysilane as the surface treatment agent and ultrasonically treating at 80° C. for 8 hours to achieve the inorganic template liquid dispersion.

200 g of the prepared polyimide liquid solution and 13 g of the prepared inorganic template liquid dispersion are mixed by stirring for 60 minutes and ultrasonically agitating for 8 hours to form the film forming liquid.

The film forming liquid is tape casted at a surface of a substrate, rested at 80° C. for 0.5 hours, dried at 100° C. for 24 hours, and demolded to obtain the organic-inorganic composite film.

The organic-inorganic composite film is disposed in HF water solution having the concentration of 20 wt % at 80° C. for 0.5 hours, repeatedly washed with deionized water, and then heated at 80° C. in vacuum for 24 hours to achieve the polyimide microporous separator. The properties of the polyimide microporous separator are shown in Table 1.

### Example 3

4.44 g of dianhydride monomer represented by the formula (1-1), 3.36 g of diamine monomer represented by the formula (2-5), and 4.28 g of diamine monomer represented by the formula (2-8) are added to 288 g of diphenyl sulfone, in argon gas, and stirred for about 50 minutes at room temperature. After the dianhydride monomer and the diamine monomers are thoroughly dissolved, 0.24 g of isoquinoline and 240 g of xylene are added, and the mixture is heated slowly to 160° C. followed by stirring at this temperature for about 24 hours to obtain a viscid polymer solution. The viscid polymer solution is precipitated in ethanol water solution having the concentration of 99 wt % and repeatedly washed, and then dried to achieve the soluble polyimide. The soluble polyimide is dissolved in dimethylformamide to form 10 wt % of polyimide liquid solution.

20 g of Al₂O₃ nanoparticles is added to 40 g of dimethylformamide and stirred to be uniformly dispersed in the dimethylformamide followed by adding 1.0 g of γ-(triethoxysilyl)propyl methacrylate as the surface treatment agent and ultrasonically treating at 60° C. for 4 hours to achieve the inorganic template liquid dispersion.

100 g of the prepared polyimide liquid solution and 30 g of the prepared inorganic template liquid dispersion are mixed by stirring for 60 minutes and ultrasonically agitating for 8 hours to form the film forming liquid.

The film forming liquid is tape casted at a surface of a substrate, rested at 70° C. for 5 hours, dried at 110° C. for 20 hours, and demolded to obtain the organic-inorganic composite film.

The organic-inorganic composite film is disposed in a HF/formic acid solution (a molar ratio of HF to formic acid is 1:9) having the total concentration of 40 wt % at 60° C. for 5 hours, repeatedly washed with deionized water, and then heated at 100° C. in vacuum for 16 hours to achieve the polyimide microporous separator. The properties of the polyimide microporous separator are shown in Table 1.

### Example 4

44.4 g of dianhydride monomer represented by the formula (1-1), 31.0 g of dianhydride monomer represented by the formula (1-2), 19.8 g of diamine monomer represented by the formula (2-9), and 50.4 g of diamine monomer represented by the formula (2-10) are added to 2000 g of sulfolane, in argon gas, and stirred for about 40 minutes at room temperature. After the dianhydride monomers and the diamine monomers are thoroughly dissolved, 3.0 g of isoquinolin-8-ol and 500 g of toluene are added, and the mixture is heated slowly to 190° C. followed by stirring at this temperature for about 24 hours to obtain a viscid polymer solution. The viscid polymer solution is precipitated in methanol water solution having the concentration of 50 wt % and repeatedly washed, and then dried to achieve the soluble polyimide. The soluble polyimide is dissolved in dimethylacetamide to form 15 wt % of polyimide liquid solution.

30 g of Al₂O₃ nanoparticles is added to 270 g of dimethylacetamide and stirred to be uniformly dispersed in the dimethylacetamide followed by adding 0.3 g of 3-glycidoxypropyltrimethoxysilan as the surface treatment agent and ultrasonically treating at 50° C. for 7 hours to achieve the inorganic template liquid dispersion.

200 g of the prepared polyimide liquid solution and 40 g of the prepared inorganic template liquid dispersion are mixed by stirring for 60 minutes and ultrasonically agitated for 7 hours to form the film forming liquid.

The film forming liquid is tape casted at a surface of a substrate, resting at 60° C. for 12 hours, dried at 100° C. for 16 hours, and demolded to obtain the organic-inorganic composite film.

The organic-inorganic composite film is disposed in an HCl solution having the concentration of 6 wt % at 65° C. for 6 hours, repeatedly washed with deionized water, and then heated at 90° C. in vacuum for 18 hour to achieve the polyimide microporous separator. The properties of the polyimide microporous separator are shown in Table 1.

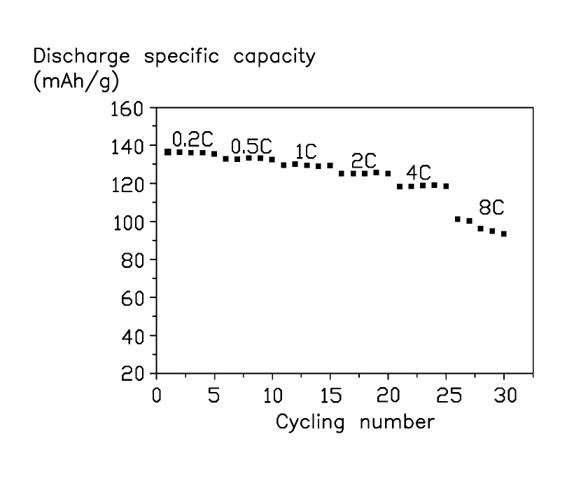

A 2032 coin type lithium ion battery is assembled using the polyimide microporous separator of Example 4, the cathode active material of which is LiCoO2, the anode electrode of which is metal lithium. The rate capability of the lithium ion battery is tested as shown in FIG. 1.

TABLE 1
the properties of polyimide microporous separators

| | Separator | Electrolyte | Tensile | Ionic | Thermal |
|---|---|---|---|---|---|
| | thickness | uptake | strength | conductivity | contraction |
| | (μm) | (%) | (MPa) | (mS/cm) | at 150° C. |
| Example 1 | 36 | 79 | 19 | 0.80 | about 0 |
| Example 2 | 29 | 52 | 27 | 0.35 | about 0 |
| Example 3 | 25 | 65 | 22 | 0.51 | about 0 |
| Example 4 | 32 | 70 | 18 | 0.65 | about 0 |

Conventional methods are used for obtaining the separator properties of Table 1.

Additionally, one of ordinary skill in the art can make changes in spirit of the present disclosure, of course, these changes according to the spirit of the present disclosure should be included in the claimed protection scope of the present disclosure.

What is claimed is:

1. A method for making a polyimide microporous separator comprising:
using a flexible monomer to prepare a soluble polyimide by a one-step method, and forming a polyimide liquid solution, comprising:
in a protective gas, adding a dianhydride monomer and a diamine monomer into an organic solvent to form a mixed liquid;
stirring the mixed liquid to dissolve the dianhydride monomer and the diamine monomer in the organic solvent, and after that, adding a catalyst to fully react at 160° C. to 200° C. to form a polyimide; and
dissolving the polyimide in an organic solvent to form the polyimide liquid solution;
providing an inorganic template being inorganic nanoparticles, and surface treating the inorganic template with a surface treatment agent in an organic solvent to dissolve the inorganic template in the organic solvent, thereby forming an inorganic template liquid dispersion;
mixing the polyimide liquid solution with the inorganic template liquid dispersion and ultrasonically agitating to form a film forming liquid;
coating the film forming liquid on a surface of a substrate and drying to form an organic-inorganic composite film; and
disposing the organic-inorganic composite film into a liquid solution of a template removing agent, the inorganic template in the organic-inorganic composite film reacting with the template removing agent to remove the inorganic template from the organic-inorganic composite film, thereby achieving the polyimide microporous separator.

2. The method for making a polyimide microporous separator of claim 1, wherein the dianhydride monomer is at least one selected from compounds having structural formulas

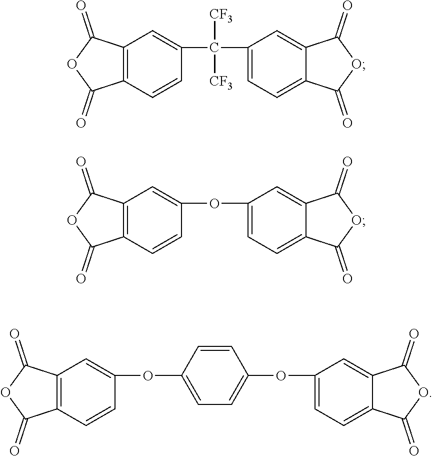

3. The method for making a polyimide microporous separator of claim 1, wherein the diamine monomer is at least one selected from compounds having structural formulas

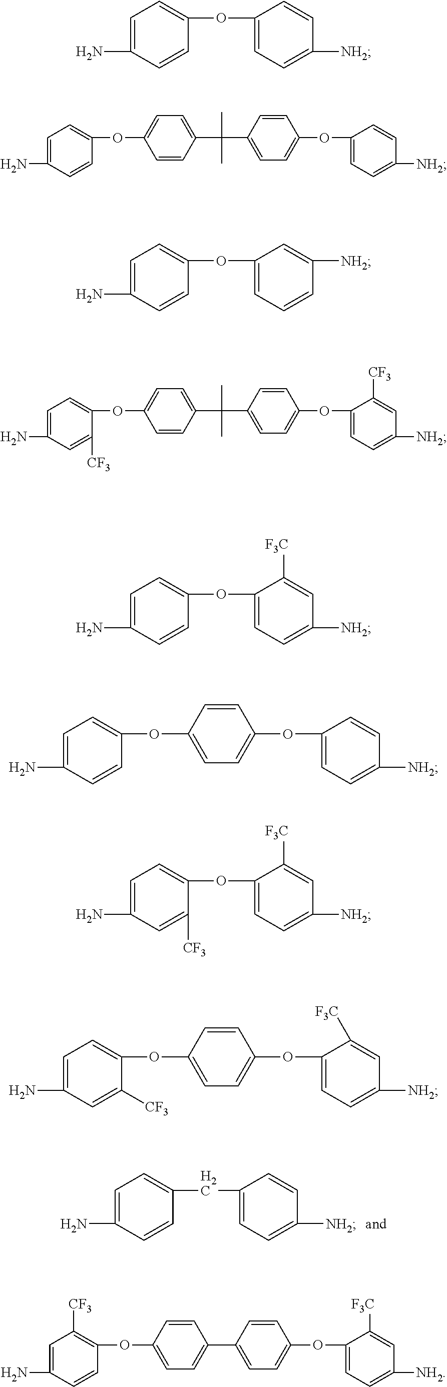

4. The method for making a polyimide microporous separator of claim 1, wherein a molar ratio between all the diamine monomer and all the dianhydride monomer is 1:1 to 1:1.05.

5. The method for making a polyimide microporous separator of claim 1, wherein the catalyst is at least one of benzoic acid, benzenesulfonic acid, toluenesulfonic acid, phenylacetic acid, pyridine, quinoline, isoquinoline, isoquinolin-8-ol, pyrrole, and imidazole.

6. The method for making a polyimide microporous separator of claim 1, wherein when the catalyst is alkaline, an azeotropic water separation agent is further added to the mixed liquid, the azeotropic water separation agent is at least one of benzene, hexane, toluene, m-xylene, p-xylene, and o-xylene.

7. The method for making a polyimide microporous separator of claim 1, wherein the inorganic template is at least one of silicon dioxide nanoparticles, titanium dioxide nanoparticles, aluminum oxide nanoparticles, calcium carbonate nanoparticles, magnesium hydroxide nanoparticles, magnesium oxide nanoparticles, magnesium carbonate nanoparticles, barium carbonate nanoparticles, zinc hydroxide nanoparticles, and zinc carbonate nanoparticles, and a mass ratio of the inorganic template to the organic solvent is 0.05:1-0.5:1.

8. The method for making a polyimide microporous separator of claim 1, wherein the surface treatment agent is at least one of vinyltrimethoxysilane, vinyltrimethoxysilane, γ-methacryloxypropyltrimethoxysilane, γ-(Triethoxysilyl)propyl methacrylate, methyltrimethoxysilane, 3-glycidoxypropyltrimethoxysilane, γ-aminopropyltriethoxysilane, triethoxy(isobutyl)silane, and butadiene triethoxysilane.

9. The method for making a polyimide microporous separator of claim 1, wherein the organic solvent is at least one of dimethylformamide, dimethylacetamide, 1,2-dichloroethane, dimethylsulfoxide, diphenyl sulfone, sulfolane, and 1-methyl-2-pyrrolidinone.

10. The method for making a polyimide microporous separator of claim 1, wherein in the film forming liquid, a mass ratio of the inorganic template to the polyimide is 0.3:1-2:1.
